(19) United States
(12) Patent Application Publication
(10) Pub. No.: US 2010/0060850 A1
(43) Pub. Date: Mar. 11, 2010

(54) COLOURED OPHTHALMIC LENSES FOR PEOPLE WITH DYSLEXIA

(75) Inventor: Guillaume Giraudet, Charenton Le Pont (FR)

Correspondence Address: OCCHIUTI ROHLICEK & TSAO, LLP, 10 FAWCETT STREET, CAMBRIDGE, MA, 02138, US

(73) Assignee: ESSILOR INTERNATIONAL (COMPAGNIE GENERALE D'OPTIQUE), Charenton Le Pont (FR)

(21) Appl. No.: 12/514,684

(22) PCT Filed: Nov. 15, 2007
(86) PCT No.: PCT/FR2007/052345

§ 371 Date: May 13, 2009

(30) Foreign Application Priority Data
Nov. 17, 2006 (FR) 0610096

(51) Int. Cl. G02C 7/10; G02C 7/06

(52) U.S. Cl. 351/165; 351/164

(57) ABSTRACT

The invention relates to an ophthalmic lens comprising, on its surface, a coloured zone the extent of which is limited to the zone of the lens explored by the eye of the user when reading, the remainder of the lens being colourless.

The present invention relates to the field of the colouration of ophthalmic lenses. More particularly, the invention relates to a novel design for the colouration of ophthalmic lenses.

Within the meaning of the invention, by “ophthalmic lenses” is meant corrective and non-corrective lenses, which are suitable in particular for a spectacle frame. Within the meaning of the invention, by ophthalmic lenses is also meant prismatic lenses, themselves corrective or non-corrective. On the other hand, the term ophthalmic lens does not include coloured contact lenses placed directly on the eye, such as those described for example in patent application GB 2 266 786. In fact, as explained hereafter, it is important for the present invention that the eye can successively and/or alternatively explore different zones of the lens, passing from a coloured zone to a colourless zone and vice versa. Such a passing of the view from one zone to another is impossible in the case of a contact lens where the eye has an essentially fixed position relative to the lens, whether the subject is reading or looking into the distance.

Developmental dyslexia is defined as a lasting difficulty with learning written language in spite of normal intellectual abilities, an absence of psychiatric or neurological disorders, a normally stimulating socio-cultural environment and appropriate schooling. This difficulty reflects a malfunction of the cognitive system responsible for reading. Dyslexia affects 8 to 10% of schoolchildren and persists throughout the individual's life, despite normal motivation. Developmental dyslexias must be distinguished from acquired dyslexias which result from cerebral lesions. Most people with dyslexia often make the same kind of mistakes: they confuse morphologically similar letters (such as p and q, b and d) and make visual mistakes with words. They have difficulty in grasping whole words and often overcome their problems with deciphering by guessing words rather than really reading them. They also experience difficulty with graphophonemic rules (in particular for complex sets of letters) often leading them to reverse letters, or even syllables. Dyslexia is sometimes accompanied by other disorders such as oral language (dysphasia), written language (dysorthographia), short-term memory, motor coordination, or also visuospatial processing disorders. Dyscalculia or attention deficit hyperactivity disorder may also be included. Dyslexia must therefore be considered as an overall learning dysfunction.

Theories to explain dyslexia are numerous and involve a laterality defect, psychoaffective disorders and above all vigilance and attention deficits. Other causes are discussed with regard to the failure to acquire written language: a minor lesional disorder of cerebral function, an unfavourable sociocultural and economic environment, unsuitable methods for learning to read, failure to respect learning progression rates.

Surprisingly, the frequency of dyslexia has increased from 3% to approximately 10% over approximately thirty years, calling into question the commonly-held idea that dyslexia is a disease of purely organic origin. Behavioural disorders associated with dyslexia can be improved using phonological, orthoptic re-education, etc. Numerous works report the use of coloured filters for treating reading disorders. These filters can vary in colour, and, according to Williams G T et al. Optometry, 2004 November; 75 (11): 720-2, the prescription of such filters is an empirical process which is difficult to repeat, requiring the adjustment of the colour of the filter in the first year of being worn. Several documents are therefore concerned with the use of coloured filters. For example, the works of Solan H A et al. J. Am. Optom. Assoc. 1997 August; 68(8):503-10 show that blue filters are capable of improving the performances of patients suffering from reading disorders. Moreover, U.S. Pat. No. 4,961,640 envisages the use of pink-coloured filters for treating patients suffering from Irlen syndrome, considered as a particular type of dyslexia. Finally, Ray, Fowler, Stein, 2005, Ann N Y Acad Sci. 1039: 283-293 show that the reading performances of people with dyslexia are improved when they wear a yellow filter in front of their eyes: such filters increase sensitivity to movement, convergence and accommodation in children with reading difficulties.

However, whatever the colour of the recommended filters, no document has taken into account the fact that, beyond the improvement provided by these filters, the perception of colours by a child wearing spectacles with coloured lenses is substantially impaired. In fact, dyslexic schoolchildren using coloured filters have to remove and replace their spectacles according to whether they are looking at the board in far vision or their sheet of paper in near vision. Thus, wearing this type of filter is inconvenient for these children and it would be useful to propose a solution to make the use of coloured filters more suitable for use by young children.

The technical problem that the present invention proposes to solve is therefore the improvement of the reading abilities of people with dyslexia by the use of coloured filters without interfering with normal colour vision.

This problem has been solved according to the present invention using ophthalmic lenses comprising a coloured zone the extent of which is essentially limited to the zone of the lens explored by the view of the user when reading. The colouration in the reading zone of the lens thus plays the known role of improving reading performance, but in a very limited zone of the lens which makes it possible to avoid any interference with normal colour vision in far vision.

As a result a subject of the present invention is an ophthalmic lens, characterized in that it comprises, on its surface, a coloured zone the extent of which is limited to the zone of the lens explored by the eye when reading, the remainder of the lens being colourless.

Preferentially, the coloured zone as defined above has a minimum transmission for wavelengths less than 480 nm, and a maximum transmission in the visible spectrum (between 400 and 700 nm (nanometres)) for wavelengths greater than 480 nm.

Advantageously, the coloured zone has a transmission of less than or equal to 50% in the wavelength range comprised between 400 nm and 480 nm, and more preferentially a transmission of less than or equal to 30% in the wavelength range comprised between 400 nm and 480 nm.

According to a preferred embodiment of the invention, the coloured zone as defined above is coloured yellow, yellow-orange or orange, colours which have proved particularly effective. In this embodiment, the fact that the yellow, yellow-orange or orange coloured zone is essentially limited to the zone explored by the eye when reading, has the additional advantage of preventing any disturbance of the circadian rhythm found in patients wearing blue-light-absorbing filters for prolonged periods. In the present invention, by contrast, the colourless peripheral zone allows sufficient blue light, which has been shown to be essential for regulating the alternation between sleep and wakefulness, to pass through.

In an embodiment of the invention, the ophthalmic lens is an afocal ophthalmic lens or a unifocal ophthalmic lens. In this embodiment, the coloured zone preferably has a circular or oval shape. Advantageously, the diameter of the coloured circular zone, or the largest dimension of the coloured oval zone, is comprised between 5 and 15 mm, preferably between 7 and 12 mm, and is in particular approximately 10 mm. The coloured zone is preferably centred on a point situated at a distance d1 comprised between 5 and 10 mm, preferentially equal to 7.5 mm, below the geometric or optical centre of the afocal or unifocal lens respectively, and at a distance d2 comprised between 1 and 4 mm, preferentially 2.5 mm, from the geometric or optical centre being displaced horizontally towards the nose.

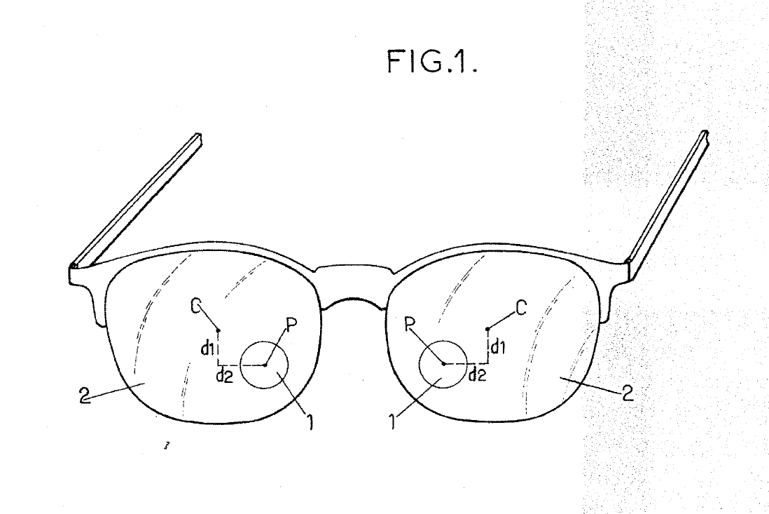

FIG. 1 illustrates this embodiment and the location of the coloured zone covering the zone explored by the eye when reading. This FIGURE shows spectacles with two unifocal lenses with an optical centre C. The coloured zone 1, in this case circular in shape, is centred on a point P situated at a distance d1 below the optical centre C and at a distance d2 from the optical centre C in the direction towards the nose. The colourless zone 2 covers all of the surface not occupied by the coloured zone.

In addition to afocal and monofocal lenses, the present invention can be applied to other types of lenses, in particular progressive lenses. This type of lens is remarkable in that it has two optical centres, i.e. a far vision optical centre and a near vision optical centre, linked by a progression corridor which allows the eye to pass gently from far vision to near vision, thus providing true visual comfort for the wearer.

A subject of a particular embodiment of the invention is therefore a progressive corrective ophthalmic lens with a far vision optical centre and a near vision optical centre. In the case of such a lens, the coloured zone is preferably circular or oval in shape and is centred around the near vision optical centre. Advantageously, the diameter of the circular coloured zone, or the largest dimension of the oval coloured zone, is comprised between 5 and 15 mm, preferably between 7 and 12 mm, and is in particular approximately 10 mm.

The dimensions of the coloured zone indicated above correspond to the ranges appropriate for most wearers of spectacles, but does not take account of individual differences. It will be easily understood that it is advantageous to limit so far as possible the dimension of the coloured zone to that of the zone actually explored by the human eye when reading in order to minimize interference with normal colour vision. Such an optimization of the relative dimensions of the coloured zones can be carried out for example using the Vision Print System technology (VPS) developed by the applicant within the context of other research into visual behaviour. This involves a device making it possible to describe the interindividual differences in eye-head coordination strategy in the visual exploration of the environment, also called “eye-head behaviour”. It is thus possible to define, on the one hand individuals who are “head movers” having a tendency to follow an object visually by a movement of the head rather than by a movement of the eye, and, on the other hand, individuals who are “eye movers” having a tendency to follow an object visually by a movement of the eyes rather than with the head.

Determination of the eye-head behaviour of a wearer of spectacles, thus makes it possible to optimize the size of the coloured zone. If the wearer has a tendency to turn their head rather than their eyes to follow an object by sight, a coloured filter of 5 to 10 mm is generally sufficient to cover the whole of the near vision zone of the lens. Conversely, if the wearer has a tendency to move their eyes rather than their head to follow an object by sight, then a coloured filter covering a relatively wider zone is recommended, for example a zone having a diameter comprised between 10 and 15 mm.

The present invention also provides another original embodiment. Studies have revealed that, apart from reading disorders, the majority of people with dyslexia also exhibit a particular deficiency in posture control called the Postural Deficiency Syndrome or PDS as described in Quercia et al., J. Fr. Ophtalmol., 2005; 28.7, 713-723. This clinical study showed that out of 60 dyslexic patients examined, 100% exhibited physical signs making it possible to establish a diagnosis of postural deficiency syndrome (PDS). The vast majority of cases observed (97%) were affected by a pure mixed PDS. PDS is a condition combining balance disorders, various pains and opthalmological symptoms. Postural deficiency syndrome is now often treated with a prescription for postural prisms; see Quercia P., Robichon F., & Alves da Silva, O. (2004) Dyslexie de développement et proprioception—Approche clinique et thérapeutique, Association Graine de Lecteur, Beaune.

Such postural prisms make it possible to correct proprioceptive anomalies by acting on the proprioceptive receptors of the oculomotor muscles. The prisms lead to a modification in the patient's spatial awareness by acting on his overall sensory balance and on head-eye coordination movements. Finally, they result in an improvement in the dyslexic patient's cognitive performances and reading ability.

Thus, in a preferred embodiment of the present invention, the ophthalmic lenses as described above also comprise a postural prism.

The prescription of postural prisms for treating postural deficiency syndrome is very well described in the scientific and medical literature. For example, Quercia P., Robichon F., & Alves da Silva, O. (2004) Dyslexie de développement et proprioception Approche clinique et thérapeutique. Association Graine de Lecteur, Beaune, proposes treating cases of pure mixed PDS with postural prisms acting on the two small oblique muscles: a first prism with a base at 125° in front of the right eye and a second prism with a base at 55° in front of the left eye, with a power of 2 and 3 diopters, the stronger prism being positioned on the side where the rotation of the head is most limited. The oblique prisms act in particular on the rotator and extensor muscles of the two lower limbs, but with an asymmetrical action: the relaxation action is greater on the side opposite the stronger prism.

Other types of prescriptions of prisms are described, and a person skilled in the art is able to adapt the shape and the power of the prism to each patient, according to his degree of postural deficiency. A majority of people with dyslexia have a pure mixed PDS, but patients also exist who are affected by predominantly left mixed PDS, predominantly right mixed PDS, left pure PDS or also affected by pure right PDS. A different prismatic treatment corresponds to each type of PDS, with prescription of prisms for both eyes or for only one eye.

It is well known to a person skilled in the art that any prismatic lens can also be corrective. Therefore a subject of the invention is also monofocal or progressive, corrective ophthalmic lenses, also comprising a postural prism.

The application of colouration to appropriate supports made of mineral or organic glass with a view to producing an ophthalmic lens according to the invention can be done for example by sublimation and/or by inkjet printing. These techniques are described for example in the patent applications WO 2006/079564 and FR 2 881 230 in the name of the applicant. It is also possible to envisage use on a substrate of a pixelated film combined with inkjet printing technology as described in the patent application WO 2006/013250.

The present invention will be better understood on reading the following examples which illustrate the subject of the invention in non-limitative manner.

### EXAMPLE 1

### Yellow Colouration of Ophthalmic Lenses According to the Invention by Inkjet Printing

40% by weight of anionic polyurethane (W234 marketed by Baxenden) is mixed under magnetic stirring with 60% by weight of colloidal silica (Ludox TM40 marketed by Aldrich). After stirring for one hour, the mixture obtained by centrifugation (spin coating) is applied to an Orma™ biplane substrate (500 revolutions/20 seconds). The deposit is dried for 1 hour at 100° C. in an oven. The thickness of the primer thus obtained is 3.6 μm. After drying, the optical lens comprising the primer and the substrate can be printed with a Canon i865 printer. The yellow zone is drawn using Powerpoint™ software. The ophthalmic lens is introduced into the loading module of the printer, the latter being connected to the computer comprising the file “yellow filter” in Powerpoint™. The printing is carried out. When the lens leaves the printer, it is immediately dried for 1 hour at 100° C. An ophthalmic lens with a yellow filter is obtained.

1. An ophthalmic lens comprising, on its surface, a coloured zone the extent of which is limited to the zone of the lens explored by the eye when reading, the remainder of the lens being colourless.

2. The ophthalmic lens according to claim 1, wherein the coloured zone has a transmission of less than or equal to 50% in the wavelength range comprised between 400 nm and 480 nm.

3. The ophthalmic lens according to claim 1, wherein the coloured zone has a transmission of less than or equal to 30% in the wavelength range comprised between 400 nm and 480 nm.

4. The ophthalmic lens according to claim 1, wherein the coloured zone is coloured yellow, yellow-orange or orange.

5. The ophthalmic lens according to claim 1, which is an afocal ophthalmic lens with the coloured zone being circular or oval in shape and centred on a point situated at a distance comprised between 5 and 10 mm below the geometric centre of the lens, and at a distance comprised between 1 and 4 mm from the geometric centre, being displaced horizontally towards the nose.

6. The ophthalmic lens according to claim 1, which is a monofocal corrective ophthalmic lens the coloured zone is circular or oval in shape and centred on a point situated at a distance comprised between 5 and 10 mm, below the optical centre of the lens and at a distance comprised between 1 and 4 mm, from the optical centre being displaced horizontally towards the nose.

7. The ophthalmic lens according to claim 1, which is a progressive corrective ophthalmic lens with a far vision optical centre and a near vision optical centre, the coloured zone being circular or oval in shape and is centred on the near vision optical centre.

8. The ophthalmic lens according to claim 5, characterized by the fact that the diameter or the largest dimension of the coloured zone is comprised between 5 and 15 mm.

9. The ophthalmic lens according to claim 1 further comprising a postural prism.

10. The ophthalmic lens according to claim 6, characterized by the fact that the diameter or the largest dimension of the coloured zone is comprised between 5 and 15 mm.

11. The ophthalmic lens according to claim 7, characterized by the fact that the diameter or the largest dimension of the coloured zone is comprised between 5 and 15 mm.
